(19) United States
(12) Patent Application Publication
(10) Pub. No.: US 2017/0115838 A1
(43) Pub. Date: Apr. 27, 2017

(54) METHOD AND APPARATUS FOR PERSONAL INTROSPECTION TOOL

(71) Applicant: Ayori Zena Selassie, Oakland, CA (US)

(72) Inventor: Ayori Zena Selassie, Oakland, CA (US)

(21) Appl. No.: 14/924,503

(22) Filed: Oct. 27, 2015

(51) Int. Cl. G06F 3/0484; G06Q 20/08; G06F 3/0481

(52) U.S. Cl. CPC G06F 3/0484; G06F 3/04817; G06Q 20/085

(57) ABSTRACT

Method and apparatus for personal introspection tool, a certification process generates certified practitioners and records of their certification, generating, maintaining and/or presenting a certified practitioner list are disclosed, as well as a fourth embodiment that can install the previous embodiments to implement them. The personal introspection tool takes into account personal, interpersonal and career dimensions of a person's life to generate their history and its life model while also taking into account information gathered from all over the world allowing them to coherently chart their life and plan their future.

### BACKGROUND OF THE INVENTION

The present invention relates generally to a personal introspection tool and more specifically to a personal introspection tool for generating and/or maintaining and/or using a history and/or a life model of a person.

While there are many processor-based personal tools available, they all provide an extroverted perspective. These tools have the disadvantage of being unable to provide an introspective perspective.

It is within this context that a need for the present invention has arisen. Thus, there is a need to address one or more of the foregoing disadvantages of conventional systems and methods, and the present invention meets this need.

### BRIEF SUMMARY OF THE INVENTION

Consider the following technical problem encountered by many individuals in today's contemporary world. While it is commonly understood that one's personal state, interpersonal relationships and career each affect one another, no tools are known to support a person mapping out these areas of their life to see the whole much less make well considered assessments and decisions based upon seeing their life as an organized whole.

Very few people have the skills to meticulously remember their past, the influences acting upon them, their decisions, values and goals, as well as to take into account information gathered from all over the world, allowing them to coherently chart their life and plan their future. Experiments attempting to do this without a computer showed significant problems, which are documented below.

Various aspects of a personal introspection tool for a person can be found in exemplary embodiments of the present invention.

In a first embodiment, the personal introspection tool may be implemented by a first processor operating in response to interactions with a user to create or use a history to generate a life model for the user. The user may also interact with the processor on behalf of another person to generate a life model of the person. The history includes data entries each including an area reference and a specific reference. The area reference may include a personal area, an interpersonal area, and/or a career area. The specific reference may include an event or a resource, for example. Other specific reference examples include an obstacle, an activity and/or a goal. The life model may be generated and/or updated by the history. The life model is configured to organize support the person becoming, and remaining, aware of their life's values, objectives, resources, obstacles, activities, both in a personal, interpersonal and career setting.

Among other functionalities, the personal introspection tool allows the person to document vital areas of the person's life including the personal area, the interpersonal area and the career area. The personal introspection tool tracks events, values, resources, and so on as time passes. The personal introspection tool's history and life model allow the person to see him or herself in a holistic fashion that is currently unavailable in any other form. In some implementations, the life model may embody the history. In other implementations, the history and the life model may be separate.

In a second embodiment, a processor may implement a certification process interacting with a second person to create a certification record as a certified practitioner for the second person. The certified practitioner may be authorized to perform a service for the person. The certified practitioner may interact with the person to generate and/or maintain the history and/or life model of the person. The certified practitioner acts as the user interacting with one of the first processors to generate and/or maintain the history and/or the life model for the person.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a personal introspection tool according to an exemplary embodiment of the present invention.

FIG. 2 illustrates an area reference of the personal introspection tool of FIG. 1 according to an exemplary embodiment of the present invention.

FIG. 3 illustrates a specific reference of the personal introspection tool of FIG. 1 according to an exemplary embodiment of the present invention.

FIG. 4 illustrates the personal introspection tool of FIG. 1 implemented as a flowchart representing a first configuration of various operations, any one or more of which the first processor may perform in its implementation of the personal introspection tool.

FIG. 5 illustrates an extension of the flowchart of FIG. 4 of some further operational steps the processor may perform when implementing the personal introspection tool.

FIG. 6 illustrates some possible refinements of generating and/or maintaining the history of FIG. 4.

FIG. 7 illustrates a refinement of FIG. 5 according to an exemplary embodiment of the present invention.

FIG. 8 illustrates a refinement to displaying the notation of FIG. 7 according to an exemplary embodiment of the present invention.

FIG. 9 illustrates possible shapes of the notational icon of FIG. 5 according to an according to an exemplary embodiment of the present invention.

FIG. 10 illustrates the color of the notational icon as a selected color of a color palette according to an exemplary embodiment of the present invention.

FIG. 11 illustrates operating a processor to implement a certification process interacting with a second person to create a certification record according to an exemplary embodiment of the present invention.

FIG. 12 illustrates the third embodiment of the present invention by operating a processor by a service provider according to an exemplary embodiment of the present invention.

FIG. 13 illustrates a fourth embodiment of the present invention by operating a fourth processor to perform additional functionalities in accordance with exemplary embodiments of the present invention.

FIG. 14 illustrates that at least one of the first processor, the second processor, the third processor, and/or the fourth processor includes at least one of a computer and/or a controller.

FIG. 15 illustrates the first processor operating in response to the first configuration to generate the history and/or the life model in accordance with exemplary embodiments of the present invention.

FIG. 16 further illustrates the first processor operating in response to the first configuration to generate the history and/or the life model in accordance with exemplary embodiments of the present invention.

FIG. 17 further illustrates the first processor responding to the user touching the “i” icon displaying a pop-up indicating how to work and live more effectively in accordance with exemplary embodiments of the present invention.

FIG. 18 further illustrates the first processor operating in response to the first configuration to connect the activities to the three areas of the personal area in accordance with exemplary embodiments of the present invention.

FIG. 19 illustrates a template of an example presented view in accordance with exemplary embodiments of the present invention.

FIG. 20 illustrates the template of FIG. 19 filled in with notational icons in accordance with exemplary embodiments of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

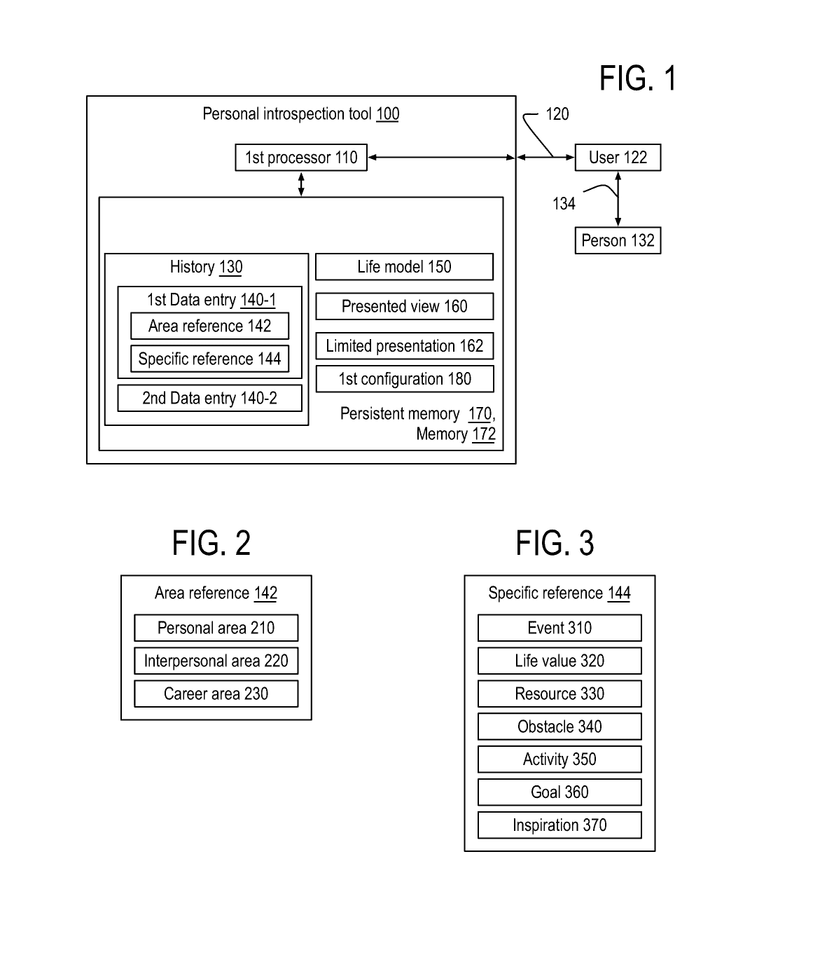

The invention is described first in terms of its operation of the various processors as illustrated in FIG. 1 through FIG. 14 and FIG. 16 through FIG. 20, and then described with reference to the interaction of user 120 with the processor 110 to generate history 130 and/or life model 150 of person 132.

As used herein, the invention includes a tool, the personal introspection tool 100 that can allow a person 132 to summarize the forces in their life on a single frame as a presented view 160 (similar to a single page of paper), which will be referred to as the life model 150 of the person 132 as shown in FIG. 1.

The life model 150 is configured to organize support the person 132 becoming, and remaining, aware of their life's values 320, objectives 370, resources 330, obstacles 340, activities 350, as shown in FIG. 3, both in their personal area 210, interpersonal area 220 and career area 230 as shown in FIG. 2.

FIG. 1 illustrates the personal introspection tool according to an exemplary embodiment of the present invention.

In. FIG. 1, personal introspection tool 100 may be implemented by processor 110 operating in response to interactions with user 122 to generate a life model, for example, for any one or more persons. Specifically, user 122 might interact, on behalf of person 132, with processor 110 to employ the person's history 130 to generate life model 150 of person 132.

The life model 150 (and personal introspection tool 100) is configured to organize and support person 132 becoming, and remaining, aware of his or her life's values, objectives, resources, obstacles, activities, both in a personal, interpersonal and career setting. The life model 150 is presentable in a single frame as the presented view 160 of all areas 142 of their life as shown in FIG. 2. The life model can also present a limited presentation 162 of a specific area, such as the career area 230 of FIG. 2, which can be provided to a career counselor without showing anyone else the personal 210 or interpersonal 220 areas of the person's 132 life.

Although not shown in FIG. 1, user 122 and person 132 may be the same entity, in which case, user 122 employs personal introspection tool 100 for him or herself. That is, user 122 might use personal introspection tool 100 with his or her own history 130 to generate an appropriate life model 150, for example.

The history 130 includes two or more data entries 140, shown as 140-1 and 140-2, each including at least area reference 142 and specific reference 144 as shown for 140-1. Life model 150 may itself be generated and/or updated by history 130, where the update is based on data entries 140. Life model 150 may allow person 132 to see themselves in a holistic fashion that is currently unavailable in any other form.

In some implementations, life model 150 may embody history 130. In other implementations, history 130 and life model 150 may be separate. For example, life model 150 may be a query-based display of history 130, responding to queries such as “what was going on in the career area when I was 25?”

Personal introspection tool 100 may further generate and/or update a presented view 160 of life model 150 and/or history 130 in terms of the areas. The personal introspection tool 100 may further limit and/or update presented view 160 to show one area to create a limited presentation 162 of the one area. By way of example, limiting life model 150 to only the career area may allow person 132 to show the limited presentation 162 to a counselor or coach having to reveal personal or interpersonal issues in the person's life.

In FIG. 1, life model 150, history 130, the data entries 140, presented view 160 and/or the limited presentation 162 may be configured for retention in a persistent memory 170. As used herein, a persistent memory 170 may include a memory 172 whose contents persist for a substantial amount of time either because the memory is non-volatile or because the memory is supplied power by a power supply that can persist, such as a battery and/or a battery-backed-up power supply.

A disk drive can also act as the persistent memory 170. The processor 110 may respond to a first configuration 180, possibly residing in the persistent memory 170 to configure the processor 110 to operate as the personal introspection tool 100.

In FIG. 1, user 122 may further interact 134 with the person 132 to generate and/or maintain history 130 and/or life model 150. Further operation of the present invention regarding the processor 110 is described below with reference to FIGS. 2 to 10.

FIG. 2 illustrates the area reference of FIG. 1 according to an exemplary embodiment of the present invention.

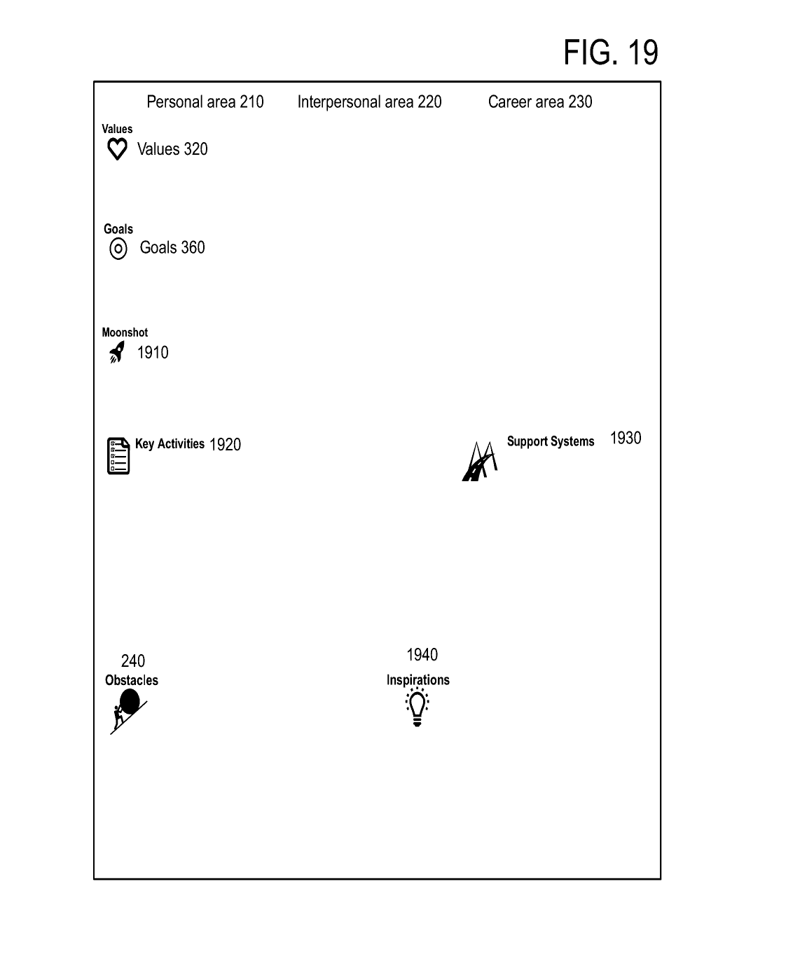

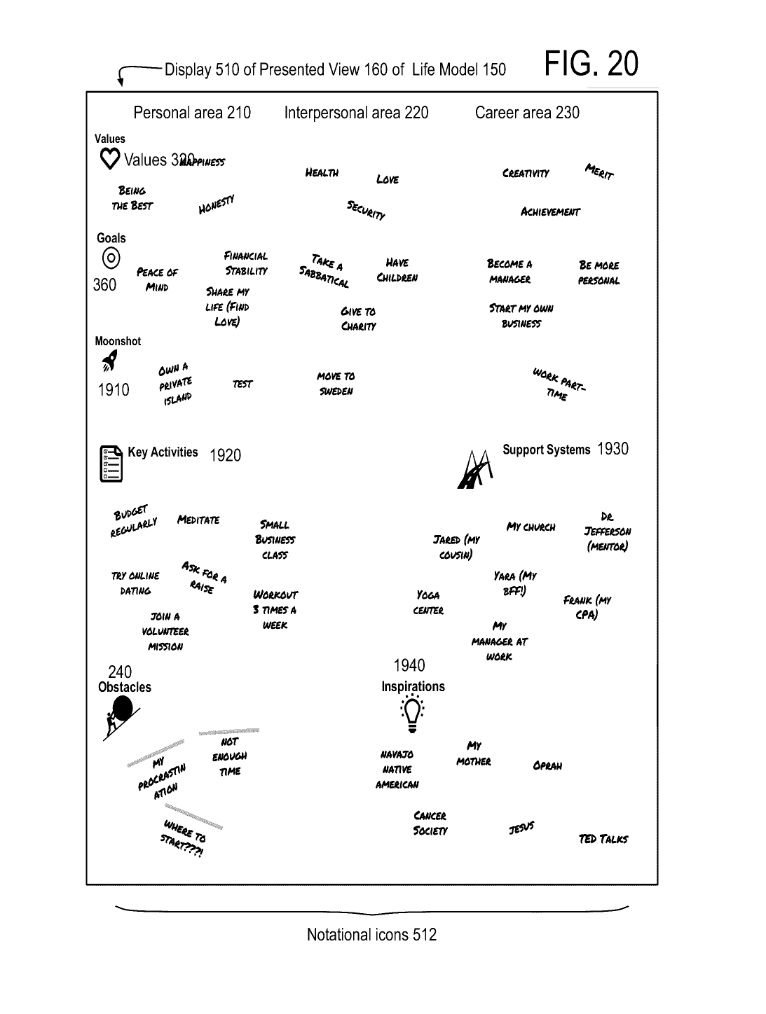

In FIG. 2, area reference 142 includes personal area 210, interpersonal area 220, and/or career area 230. Personal area 210 is also showing in FIG. 19 illustrating a user interface as perceived by the user. As implied by its name, personal area 210 is configured to receive personal user data such as values 310 (FIG. 19) that resonate with a person or goals 360 (FIG. 19) that a person wishes to attain. An example of a value might be happiness as shown in the PERSONAL area of FIG. 20. Another example of a goal might be stability as shown in the Goals area of FIG. 20.

Interpersonal area 220 may be configured to receive family data as shown by family 220 in FIG. 19. Examples of family data are health, love, security, etc., as illustrated in FIG. 20.

Career area 230 is configured to receive career data, the area being shown as career 230 in FIG. 19. An example of career data is to “become a manager” as illustrated in FIG. 20 under the CAREER area.

FIG. 3 illustrates a specific reference of the personal introspection tool of FIG. 1 according to an exemplary embodiment of the present invention.

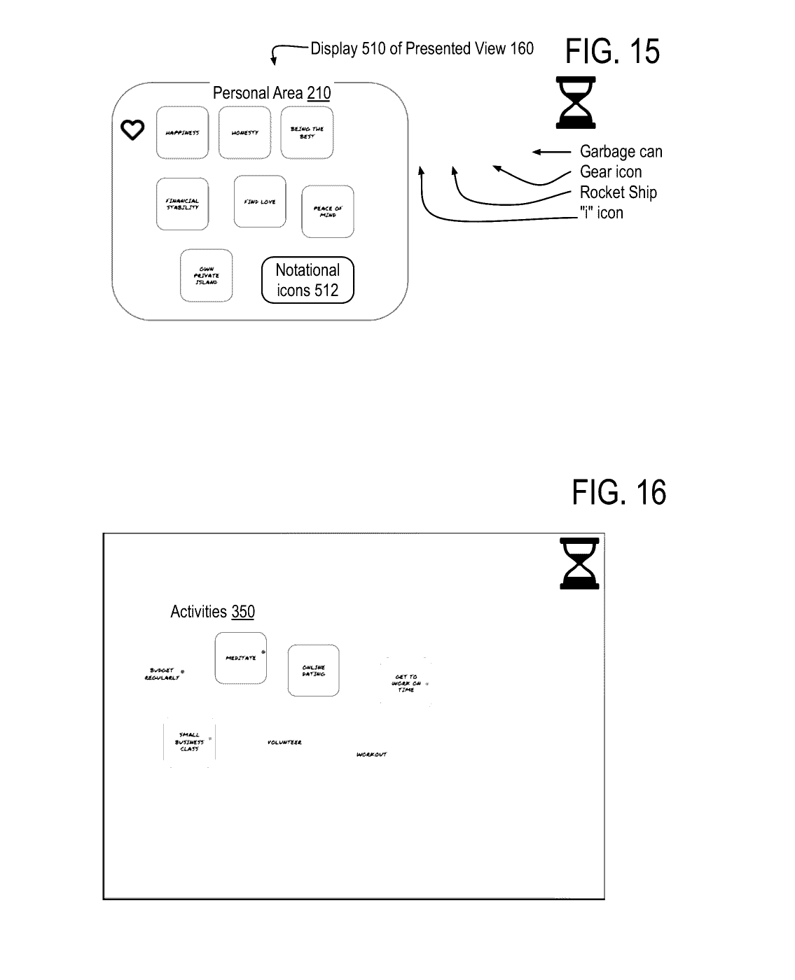

In FIG. 3, the specific reference 144 of FIG. 1 may include an event 310, a life value 320, a resource 330, an obstacle 340, an activity 350, a goal 360 and/or an inspiration 370. As used herein, an inspiration 370 may refer to something that helps propel the person 132 forward by empowering, or potentially empowering, the person 132 to move forward in some situations. Use of specific references 144 is described with reference to FIGS. 15 to 20.

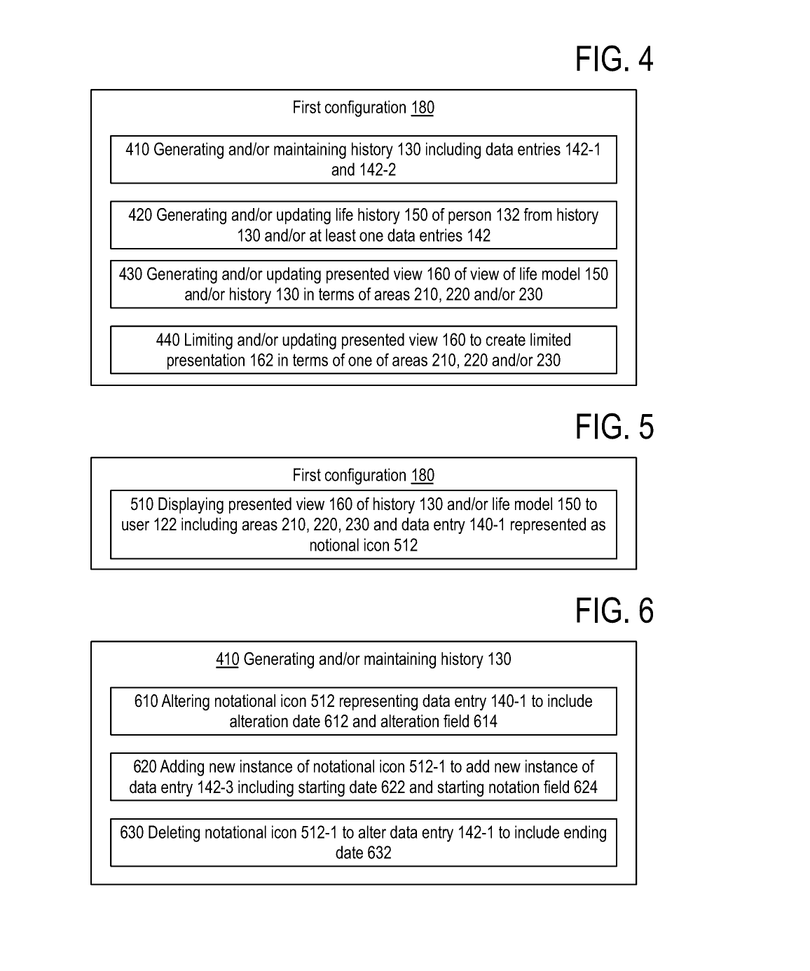

FIG. 4 illustrates a flow chart of a method associated with personal introspection tool 100 of FIG. 1 in accordance with an exemplary embodiment of the present invention.

In FIG. 4, the flow chart represents first configuration 180 that may be implemented by one or more processors 110. As shown in FIG. 4, the flow chart is initiated at block 410, which generates and/or maintains history 130 (FIG. 1) for person 132. As previously noted, history 130 includes data entries 140 having area reference 142 and specific reference 144. Area reference 142 further includes personal area 210, interpersonal area 220 and/or career area 230 of FIG. 2. Specific reference 144 includes event 310, life value 320, resource 330, obstacle 340, activity 350 and/or a goal 360 of FIG. 3.

At block 420, the generated history 130 is used to generate and/or update life model 150. The update may also be based on data entries 140.

At block 430, the flow chart generates presented view 160 of a view of the life model 150 and/or history 130 in terms of the areas.

At block 440, presented view 160 (FIG. 1) is limited or updated such that a single area is shown so as to create a limited presentation 162 of the one of the areas: personal area 210, interpersonal area 220 or career area 230 of FIG. 2. In some implementations or through the direction of the user 122 and/or person 132, the limited presentation 162 may show only the career area 230.

FIG. 5 illustrates an extension of first configuration of FIG. 4 to include displaying the presented view.

In FIG. 5, block 510 displays the presented view 160 of history 130 and/or life model 150 to the user 122. The presented view 160 may include an area reference 142 and at least one of data entries 142-1 and/or 142-2 may be represented in a presented view 160 as the notational icon 512.

FIG. 6 illustrates some possible refinements of the operation of block of FIG. 5.

In FIG. 6, block 610 alters notational icon 512 representing the data entry 140 to alter the data entry 140-1 to include an alteration date 612 and an alteration field 614. In FIG. 6, block 620 refers to adding a new instance of one notational icon 512-1 to add a new instance of the data entry 140-3 including a starting date 622 and a starting notation field 624. In FIG. 6, block 630 refers to deleting the notational icon 512-1 representing the data entry 142-1 to create an ending date 632 for the data entry 142-1.

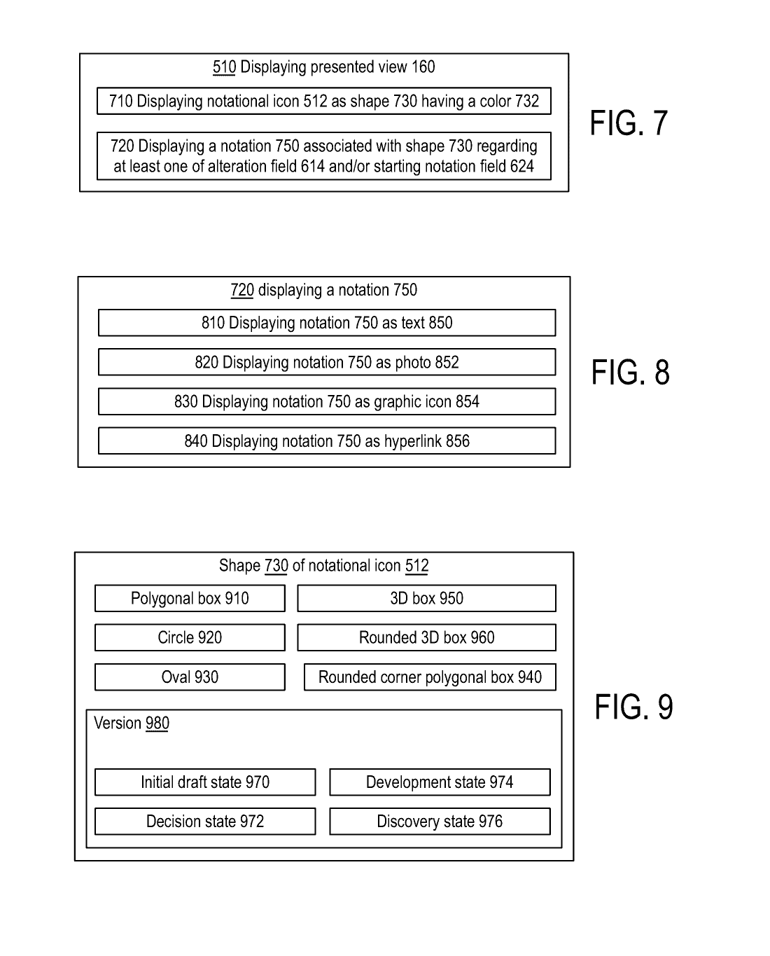

FIG. 7 illustrates a refinement of FIG. 5 according to an exemplary embodiment of the present invention.

In FIG. 7, a refinement to block 510 (FIG. 5) may display the presented view 160 that may further include at least one of the following: block 710 refers to displaying the notational icon 512 as a shape 730 having a color 732; block 720 refers to displaying a notation 750 associated with the shape 730 regarding at least one of the alteration field 614 and/or the starting notation field 624.

FIG. 8 illustrates a refinement to the block displaying the notation of FIG. 7.

In FIG. 8 the refinement to block 720 displaying the notation 750 may further include at least one of the following: block 810 refers to displaying the notation 750 as text 850; block 820 refers to displaying the notation 750 as a photo 852. Block 830 refers to displaying the notation 750 as a graphic icon 854; and block 840 refers to displaying the notation 750 as a hyperlink 856.

By way of example, displaying the notation 750 may include displaying the text 850 of an individual's name and the photo 852 of the individual. By way of a second example, displaying the notation 750 may include displaying the graphic icon 854 and the hyperlink 856, where the graphic icon 854 may be a corporate logo and the hyperlink 856 may open a browser and/or application to access a corporate web site or to post a query. The response to triggering the hyperlink 856 may be presented in history 130 and/or life model 150.

In FIG. 8, the hyperlink 856 may refer to a hyper-text markup language form of a hyperlink. The hyperlink 856 may also act as a handle for an object-oriented tool, possibly written in a language such as Java or C++ that may serve as a portal to possibly web-based tools such as data mining tools which can examine personal as well as public databases. A surfer may want a tool to keep track of local tides to know when there will likely be good surfing conditions. A gardener may want to know optimal transplanting times. Person 132 may want to know how many job postings there are for someone with their skills, how long it has been since they balanced their checkbook, went to a symphony, or visited a park.

Experimental Evidence: according to the inventor documenting her experiences using “Post-its®” on a white board to generate and maintain life models 150, users could not easily maintain a history 130 of life model 150, found it difficult to keep private because the sheets of paper were large, and also found it difficult to transport or access in a mobile fashion for reuse and further updates.

Data within life model 150 was also more difficult to share as specific sections when on paper because the entire life model 150 is on a single sheet and one may not want everyone to see one's personal, or interpersonal goals if all one wishes to share are one's career goals. Privacy was a big hurdle, also portability, ease of access, reportability, and no machine learning algorithms could be linked 856 (applied) when using life model 150 on paper or on a white board.

FIG. 9 illustrates the shape of the notational icon of FIG. 7 according to an exemplary embodiment of the present invention.

In FIG. 9 the shape 730 of the notational icon 512 may be a version of at least one of a polygonal block 910, a circle 920, an oval 930, a rounded corner polygonal block 940, a 3D block 950 and/or a rounded 3D block 960 possibly including a version 980 indicating at least one of an initial draft state 970, a decision state 972, a development state 974 and/or a discovery state 976. Typically, the shape 730 of the notational icon 512 has a version 980 that starts as an initial draft state 970. The version 980 may evolve through a discovery state 976, for instance, so that the person 132 may take the life model 150 and/or the history 130 home. The discover state 976 can be used to help the person observe what is going on in their life, as well as aid the person 132 in checking the accuracy of the history 130 and/or the life model 150. After the discovery state 976, the person 132 may make one or more decisions regarding the part of themselves represented by the notational icon 512, and the version 980 may become the decision state 972. Once decisions have been made, the person 132 may designate one or more habits to develop and begin work on these habits, leading the version 980 to become the development state 974. As used herein, a polygon has at least three edges terminating in the same number of points as edges.

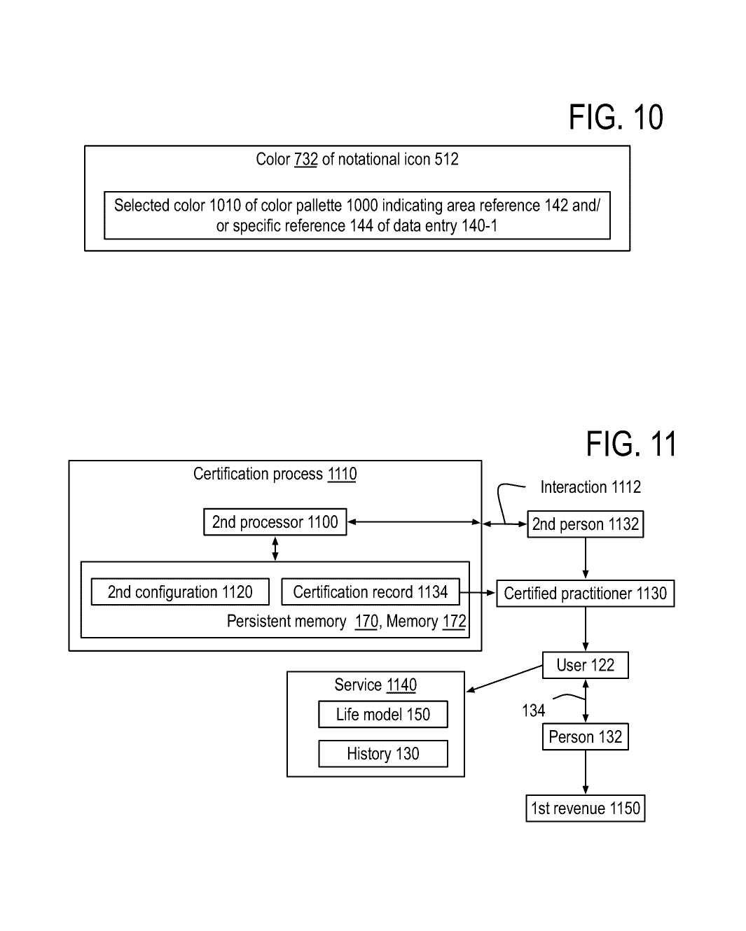

FIG. 10 illustrates the color of the notational icon as a selected color of a color palette according to an exemplary embodiment of the present invention.

In FIG. 10 the color 732 of the notational icon 512 is a selected color 1010 of a color palette 1000 indicating at least one of the area reference 142 and/or the specific reference 144 of the data entry 140-1.

FIG. 11 illustrates operating a processor to implement a certification process interacting with a second person to create a certification record according to an exemplary embodiment of the present invention.

In FIG. 11, a second processor 1100 may be operated to implement a certification process 1110 that interacts 1112 with a second person 1132 to create a certification record 1134.

In FIG. 11, the certification record 1134 designates the second person 1132 as a certified practitioner 1130. The authorized practitioner 1130 is authorized to perform a service 1140 for person 132 as the user 122 of the processor 110. The authorized practitioner 1130 performs the service 1140 in exchange for first revenue 1150. The service entails interacting 134 with person 132 to generate the life model 150 for person 132, possibly through generating the history 130 of the person as first shown in FIG. 1.

In FIG. 11, the second processor 1100 may be responding to a second configuration 1120, possibly implemented in response to instructions contained in a memory 172 or 170 configured for access by the second processor 1100 to implement the certification process 1110.

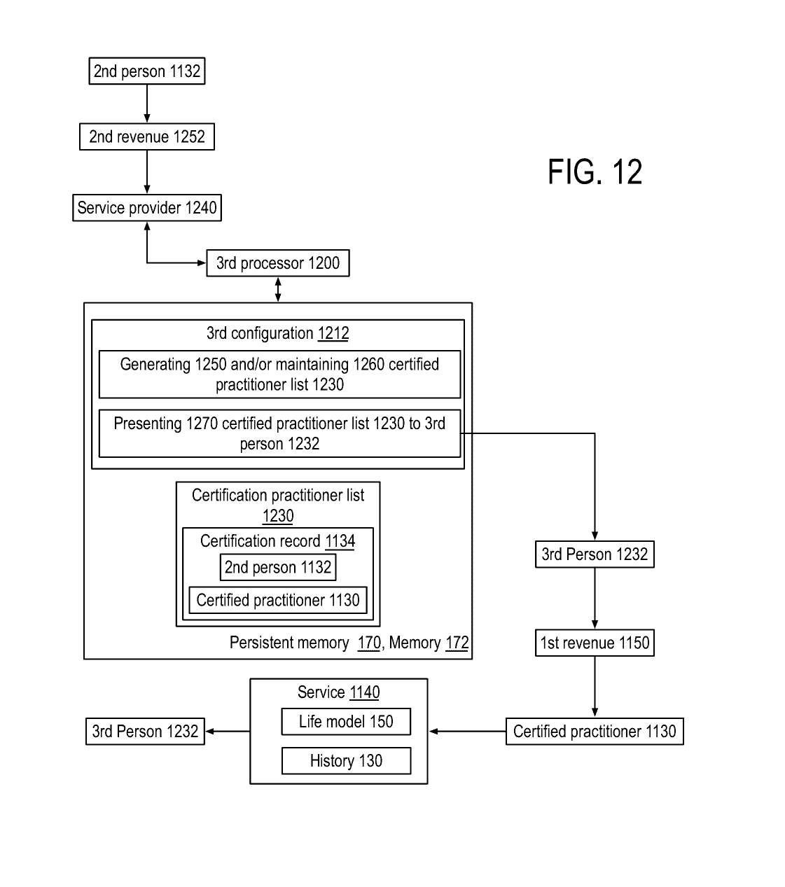

FIG. 12 illustrates a service provider operating a third processor to generate and/or maintain a certified practitioner list according to an exemplary embodiment of the present invention.

In FIG. 12, the service provider 1240 may receive second revenue 1252 from the second person 1132, who has interacted 1112 with the certification process of FIG. 11 to create the certification record 1134. The second revenue compensates the service provider for the certified practitioner list 1230 include the certification record 1134 designing the second person as the certified practitioner 1130. The second revenue may also compensate the service provider for the presenting 1270 the certified practitioner list 1230 to a third person 1232.

In FIG. 12, the third person 1232 may respond to the certified practitioner list 1230 by selecting the certified practitioner 1130. The third person may pay the certified practitioner the first revenue 1150. The certified practitioner may respond to receipt of the first revenue by providing the service 1140 of generating at least one of the life model 150 and the history 130 of the third person.

In FIG. 12, the third processor 1200 may be operating in response to a third configuration 1212. The third configuration may include at least one of the generating 1250 the certified practitioner list 1230, maintaining 1260 the certified practitioner list, and presenting 1270 the certified practitioner list to a third person 1232. The third configuration 1212 may be implemented as instructions contained in a memory 170 and/or 172.

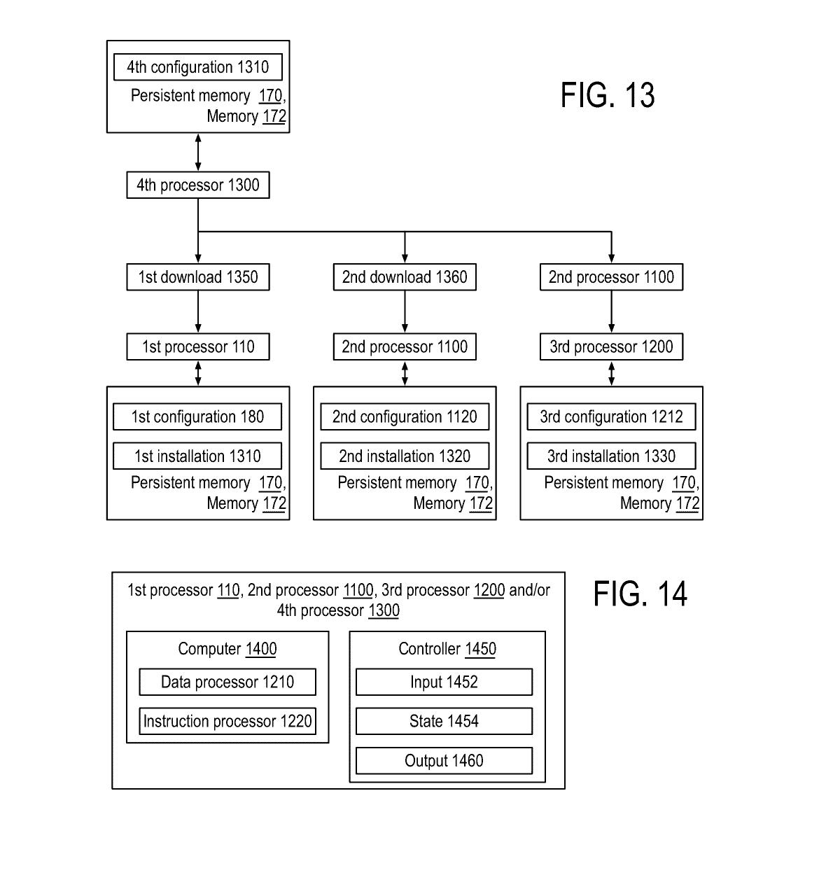

FIG. 13 illustrates a fourth processor configured to deliver at least one of the first configuration, the second configuration and the third configuration to a corresponding processor in accord with an exemplary embodiment of the present invention.

In FIG. 13 the fourth processor 1300 interacts with the processor 110 of FIG. 1 to download a first installation to configure the processor 110 to implement the personal introspection tool 100 for the user 122.

In FIG. 13 the fourth processor 1300 interacts with the second processor 1100 to download a second installation 1320 to configure the second processor 1100 to implement the certification process 1110 of FIG. 11.

In FIG. 13 the fourth processor 1300 interacts with the third processor 1200 of FIG. 12 to download a third installation 1330 to configure the third processor 1200 to generate, maintain and/or present the certified practitioner list 1230.

In FIG. 13, at least one of the configurations 180, 1120, 1212 and/or 1310 may be implemented as instructions residing in a memory 172 configured and adapted for access by the computer 1400 to instruct the computer 1400 of FIG. 14 to perform those instructions by at least one of the processors 110, 1100, 1200, and/or 1300, respectively.

FIG. 14 illustrates that at least one of the processors includes at least one of a computer and/or a controller in accord with an exemplary embodiment of the present invention.

In FIG. 14, at least one of the processor 110, the second processor 1100, the third processor 1200, and/or the fourth processor 1300 may include at least one of a computer 1400 and/or a controller 1450.

In FIG. 14, the computer 1400 may include at least one data processor 1210 and at least one instruction processor 1220. At least one of the data processors 1210 may be instructed by at least one of the instruction processors 1220 to at least partly implement at least one of the personal introspection tool 100, the certification process 1110, generating 1250 the certified practitioner list 1230, maintaining 1260 the certified practitioner list 1230 and/or presenting 1270 the certified practitioner list 1230.

In FIG. 14, the controller 1450 may include at least one input 1452, and at least one output 1460 generated in response to at least one value of at least one of the input 1452 and/or the value of at least one state 1454.

In FIG. 14, the controller 1450 may at least partly implement at least one of the personal introspection tool 100, the certification process 1110, generating 1250 the certified practitioner list 1230, maintaining 1260 the certified practitioner list 1230 and/or presenting 1270 the certified practitioner list 1230.

FIG. 15 illustrates generating the history and/or life model through interaction with a display of the presented view in accord with an exemplary embodiment of the present invention.

In FIG. 15, the processor 110 operates in response to the first configuration 180 to generate history 130 and/or life model 150 through interaction 120 with a display 510 of presented view 160 focused on the personal area 210.

In FIG. 15, the user 122 may be guided by the first configuration 180 to successively generate data entries 140 with area references 142 to the personal area 210 as shown here and subsequently generate data entries with area references to the interpersonal area 220 and/or the career area 230.

By way of example, this section of presented view 160 may include a menu that includes a “Garbage can” icon that may indicate deleting the section and starting over. The menu may include a “gear” icon that may indicate configuration settings to add application program interface connections that may be implemented as essentially hyperlinks 856. The menu may include a “Rocket ship” icon that may indicate special resources and information. Also, the menu may include an “I” icon that may indicate insights and/or information. Alternatively, the personal area 210 may begin by outlining the life values 320 of person 132 as shown in this illustration.

FIG. 16 illustrates the display of presented view focused on activities across the personal area, the interpersonal area and the career area in accord with an exemplary embodiment of the invention.

In FIG. 16, the activities 350 addressed in the personal area 210 may include meditating and online dating. The activities 350 in the career area 230 may include taking a small business class and getting to work on time. The activities 350 in the interpersonal area 220 may include budgeting regularly, volunteering and working out.

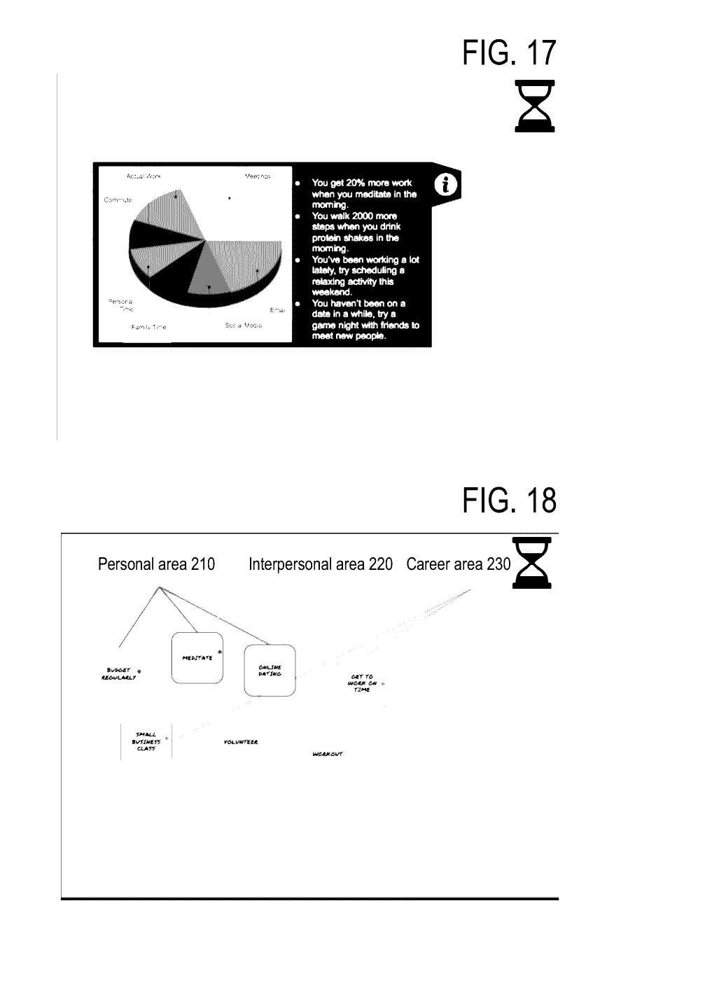

FIG. 17 illustrates the response to the user touching the “i” icon displaying a pop-up indicating some helpful general insights or information regarding how to work and live more effectively by incremental changes in the person life style.

In FIG. 17, the processor 110 responds to the user 122 touching the “i” icon displaying a pop-up indicating some helpful general information regarding how to work and live more effectively by incremental changes in the person 132's life style. For example, person 132 may get 20% more work done when the person meditates in the morning. Person 132 may walk 2000 more steps when the person drinks protein shakes in the morning. When person 132 has been working a lot lately, scheduling a relaxing activity for the weekend may be a good suggestion. If person 132 is single, and the person has not been on a date in a while, suggesting a game night with friends may be a way to meet new people.

FIG. 18 illustrates connecting various examples of activities to the personal area, the interpersonal area and the career area ion accord with an exemplary embodiment of this invention.

The activities 350 addressed in the personal area 210 may include meditating or online dating. The activities 350 in the career area 230 may include taking a small business class and getting to work on time. The activities 350 in the interpersonal area 220 may include budgeting regularly, volunteering and working out. Note that budgeting regularly may connect to both the personal area 210 and the interpersonal area 220, more specifically the family.

FIG. 19 illustrates a template of the presented view.

In FIG. 19, the template is an example of presented view 160, including the personal area 210, the interpersonal area 220 represented by family, and the career area 230 designated along the top of presented view 160 and can frequently be shown as rough columns through presented view 160.

In FIG. 19, the life values 320 are described as clear values that resonate with the person 132's heart, mind, body and spirit. The goals 360 are described as the top three goals. The moonshot 1910 is described as the “impossible dream.” The activities 350 are described as the key activities 1920 that will contribute to the success of the goals 360 across one or more tracks, or areas 210, 220, and/or 230. The resources 330 are described as support systems 1930 which may include, but are not limited to, environment, people, accountability, partners, business partners, organizations and resources guiding and/or supporting the person 132's path to success.

In FIG. 19, the obstacles 240 are described as answering any combination of the following. What keeps person 132 up at night? What people, organizations or behaviors restrict the person 132's success? What challenges is person 132 facing in his or her personal 210 life, family (interpersonal 220 life) or career 230?

In FIG. 19, the inspirations 1940 are described as answering any combination of the following. What makes person 132 wake up excited in the morning? What does person 132 share with friends and those closest to him or her? What would person 132 not change in his or her life for anything? Who does the person respect, admire, love and why?

FIG. 20 illustrates the template of FIG. 19 filled in with notational icons.

In FIG. 20, some of the notational icons 512 may represent each the personal area 210, the interpersonal area 220 and the career area 230 with data entry values for life values 320, goals 360, activities 350, resources 330, obstacles 340 and inspirations 1940.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method, comprising:
operating a first processor to implement a personal introspection tool in response to interactions with a user to generate a history and/or a life model of a person, further comprising
generating the history including a plurality of data entries regarding the person, each of the data entries including an area reference and a specific reference, the area reference including at least one of personal, interpersonal and/or career areas, the specific reference including at least one of an event, a life value, a resource, an obstacle, an activity and/or a goal;
generating the life model of the person from the history and the data entries, configured to organize the support for the person's awareness of their life's values, objectives, resources, obstacles, activities, in the personal, interpersonal and career areas;
generating a presented view of the life model and/or the history in terms of the areas; and
limiting the presented view to show one area to create a limited presentation of one area;
wherein at least one of the life model, the history, the data entries, presented view and/or the limited presentation is configured for retention in a persistent memory.

2. The method of claim 1 wherein the limited presentation shows only the career area.

3. The method of claim 1, further comprising
displaying presented view of the history and/or the life model to the user including at least one of the areas and at least one of the data entries represented in presented view as a notational icon;
wherein generating and/or maintaining the history and/or the life model includes at least one of
altering the notational icon representing the data entry to alter the data entry including an alteration date and an alteration field;
adding a new instance of one notational icon to add a new instance of the data entry including a starting date and a starting notation field; and/or
deleting the notational icon representing the data entry to create an ending date for the data entry.

4. The method of claim 3,
wherein displaying presented view further comprises at least one of
displaying the notational icon as a shape having a color, and displaying a notation associated with the shape regarding at least one of the alteration field and/or the starting notation field.

5. The method of claim 4 wherein the displaying the notation includes at least one of
displaying the notation as text and/or
displaying the notation as a photo and/or
displaying the notation as a graphic icon and/or
displaying the notation as a hyperlink.

6. The method of claim 5, wherein the notational icon further includes at least one of
the shape as a version of at least one of a polygonal box, a circle, an oval, a rounded corner polygonal box, a 3D box and/or a rounded 3D box with the version indicating at least one of an initial draft state, a decision state, a discovery state and/or a development state;
the color as a selected color of a color palette indicating at least one of the area reference and/or the specific reference of the data entry.

7. The method of claim 1, further comprising
operating a second processor to implement a certification process interacting with a second person to create a certification record designating the second person as a certified practitioner authorized to perform a service for the person as the user of the first processor in exchange for a first revenue to interact with the person to generate the history and/or the life model for the person.

8. The method of claim 3, further comprising
operating a third processor by a service provider to perform at least one of
generating and/or maintaining a certified practitioner list indicating the second person as the certified practitioner resulting from the certification record and in exchange for a second revenue received from the second person; and/or
presenting the certified practitioner list to a third person to identify the second person for the third person to engage the second person as the certified practitioner to perform the service for the third person in exchange for the first revenue.

9. The method of claim 4, further comprising
operating a fourth processor to perform at least one of
interact with the first processor to download a first installation to configure the first processor to implement the personal introspection tool for the user;
interact with the second processor to download a second installation to configure the second processor to implement the certification process for the second person; and/or
interact with the third processor to download a third installation to configure the third processor to implement at least one of generating and/or maintaining the certified practitioner list and/or presenting the certified practitioner list.

10. The method of claim 5, wherein at least one of the first processor, the second processor, the third processor and/or the fourth processor includes at least one of a computer and/or a controller;
wherein the computer includes at least one data processor and at least one instruction processor;
wherein at least one of the data processors is instructed by at least one of the instruction processors to at least partly implement at least one of the personal introspection tool, the certification process, generating and/or maintaining the certified practitioner list and/or presenting the certified practitioner list;
wherein the controller includes at least one input, and at least one output generated in response to at least one value of at least one of the input and/or the value of at least one state; wherein the controller at least partly implements at least one of the personal introspection tool, the certification process, generating and/or maintaining the certified practitioner list and/or presenting the certified practitioner list.

11. An apparatus, comprising a persistent memory containing at least one of
a first configuration of a first processor to implement a personal introspection tool for a person to create and/or use a history and/or a life model of the person;
a second configuration of a second processor to implement a certification process interacting with a second person to create a certification record indicating the second person as a certified practitioner authorized to operate the first processor as the personal introspection tool for the person to create and/or use the history and/or the life model of the person;
a third configuration of a third processor to generate and/or maintain a certified practitioner list based upon the certification record of the second person and/or presenting the certified practitioner list to a third person identifying the second person as a certified practitioner to operate the personal introspection tool for the person; and/or
a fourth configuration of a fourth processor to implement at least one of
interact with the first processor to download a first installation of the first configuration to implement the personal introspection tool;
interact with the second processor to download a second installation of the second configuration to implement the certification process; and/or
interact with the third processor to download a third installation of the third configuration regarding the certified practitioner list.

12. The apparatus of claim 11,
wherein the first configuration configures the first processor to perform
generating the history including a plurality of data entries regarding the person, each of the data entries including an area reference and a specific reference, the area reference including at least one of personal, interpersonal and/or career areas, the specific reference including at least one of an event, a life value, a resource, an obstacle, an activity and/or a goal;
generating the life model of the person from the history and/or at least one of the data entries;
generating a presented view of the life model and/or the history in terms of the areas; and/or
limiting presented view to show one area to create a limited presentation of the one area.

13. The apparatus of claim 12 wherein the limited presentation shows only the career area.

14. The apparatus of claim 12 further comprising the first processor configured to implement the personal introspection tool.

15. The apparatus of claim 11, further comprising
the second processor configured to implement the certification process interacting with the second person to designate the second person as the certified practitioner authorized to perform a service for the person in exchange for a first revenue to generate the history and/or the life model for the person.

16. The apparatus of claim 11 further comprising
the third processor configured for operation by a service provider to perform at least one of
generating and/or maintaining a certified practitioner list indicating the second person as the certified practitioner resulting in the certification record and in exchange for a second revenue received from the second person; and/or
presenting the certified practitioner list to a third person to identify the second person for the third person to engage the second person as the certified practitioner to perform the service for the first person in exchange for the first revenue.

17. The apparatus of claim 16, further comprising
the fourth processor configured to interact with the persistent memory to perform at least one of
interact with the first processor to download the first installation to configure the first processor to implement the personal introspection tool for the person;
interact with the second processor to download the second installation to configure the second processor to implement the certification process for the second person; and/or
interact with the third processor to download the third installation to configure the third processor to implement at least one of generating and/or maintaining the certified practitioner list and/or presenting the certified practitioner list.
The apparatus of claim 17 wherein at least one of the first processor, the second processor, the third processor and/or the fourth processor includes at least one of a computer and/or a controller;
wherein the computer includes at least one data processor and at least one instruction processor;
wherein at least one of the data processors is instructed by at least one of the instruction processors to at least partly implement at least one of the personal introspection tool, the certification process, generating and/or maintaining the certified practitioner list and/or presenting the certified practitioner list;
wherein the controller includes at least one input, and at least one output generated in response to at least one value of at least one of the input and/or the value of at least one state; wherein the controller at least partly implements at least one of the personal introspection tool, the certification process, as well as generating, maintaining and/or presenting the certified practitioner list.
